(19) United States
(12) Patent Application Publication
(10) Pub. No.: US 2008/0209754 A1
(43) Pub. Date: Sep. 4, 2008

(54) Drying Rack in Dryer

(75) Inventors: Seong Hae Jeong, Gyeongsangnam-Do (KR); Juhan Yoon, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS, INC., Youngdungpo-gu (KR)

(21) Appl. No.: 10/556,343

(22) PCT Filed: Jul. 19, 2005
(86) PCT No.: PCT/KR05/02326

§ 371 Date: Feb. 7, 2007

(30) Foreign Application Priority Data
Jul. 20, 2004 (KR) 2004-56199

(51) Int. Cl. F26B 25/00; A47G 29/00

(52) U.S. Cl. 34/239; 211/85.3

(57) ABSTRACT

The present invention relates to a laundry dryer, and more particularly, to a drying rack in a drum of a dryer for drying objects other than clothes, such as shoes. To achieve the object of the present invention, a drying rack in a dryer includes a rack detachably mounted to an inside of a drying drum for placing a drying object thereon, and at least one drying stick for supporting the drying object spaced a predetermined distance from the rack. Accordingly, since the drying object placed on the drying stick is not shaded by the ribs of the seat from the hot air, the drying rack in a dryer of the present invention can dry the drying object, uniformly.

### TECHNICAL FIELD

The present invention relates to a laundry dryer, and more particularly, to a drying rack in a drum of a dryer for drying objects other than clothes, such as shoes.

### BACKGROUND ART

In general, the dryer heats external air drawn thereto and blows to an inside of a drying drum forcibly, and, at the same time with this, rotates the drum, to dry objects held in the drying drum.

In the meantime, of the objects to be dried, objects each of which weighs to some extent, such as shoes, give impact to the drying drum as the objects are lifted and dropped by lifters on an inside circumference of the drying drum when the drying drum rotates, to cause heavy noise.

Consequently, a drying rack is mounted additionally to an inside of the drying drum regardless of rotation of the drying drum, for drying objects, such as shoes, placed on the drying rack.

A related art drying rack will be described with reference to the attached drawings.

FIG. 1 illustrates a perspective view of a related art drying rack.

Referring to FIG. 1, the related art drying rack 10 is provided with a seat 2 for placing drying objects thereon, and securing portions 8a, and 8b for supporting the seat 2 spaced a predetermined distance from an inside circumferential surface of the drying drum (not shown).

The seat 2 has a plurality of ribs 4 perpendicular to each other at regular intervals, to form pass through holes 6 for pass of air.

The securing portions 8a, and 8b have a front securing portion 8a at a front side of the seat 2 for being secured to an upper surface of a filter unit (not shown) on a front side of an inside of the dryer, and a rear securing portion 8b at a rear side of the seat 2 for being placed on an inside circumferential surface of a rear supporter (not shown) mounted on a rear side of an inside of the dryer.

The front securing portion 8a is projected forward from front left/right edges of the seat 2, so that the front securing portion 8a is placed on an upper surface of the filter unit when the drying rack 10 is mounted.

The rear securing portion 8b is projected downward from rear left/right edges of the seat 2, so that the rear securing portion 8b is placed on an inside circumferential surface of the rear supporter when the drying rack 10 is mounted.

Thus, after objects, such as shoes, are placed on the seat 2 of the drying rack 10 mounted in the drum (not shown), a drying process of the objects are performed.

However, the related art drying rack 10 has problems in that a loading capacity is small because a space for receiving the drying objects are restricted to the seat 2, and drying efficiency for the drying objects is poor because an area the drying objects are in contact with the ribs 4 of the seat 2 is large, to cause portions of the drying objects to be shaded by the ribs 4 from hot air supplied from under the seat 2 to the drying objects through the plurality of pass through holes 6 in the seat 2.

### DISCLOSURE OF INVENTION

### Technical Problem

The object of the present invention is to provide a drying rack in a dryer, in which drying rack structure is improved, to increase a loading capacity, and providing hot air to drying objects in a drum uniformly for improving drying efficiency.

### Technical Solution

The object of the present invention can be achieved by providing a drying rack in a dryer including a rack detachably mounted to an inside of a drying drum for placing a drying object thereon, and at least one drying stick for supporting the drying object spaced a predetermined distance from the rack.

The rack may include a seat having a plurality of pass through holes for pass through of drying air, and a securing portion for supporting the seat spaced from a predetermined distance from an inside circumferential surface of the drying drum.

Preferably, the drying stick is detachable from the rack.

The drying stick may be formed to be extended upward from the rack.

The drying rack may further include a seating plate at an end of the drying stick for seating the drying object thereon.

The drying rack may further include a branch stick having one end fixedly secured to a side of the drying stick, and the other end supporting the seating plate.

Preferably, the branch stick is formed as one body with the drying stick, and preferably the end of the drying stick and the end of the branch stick are at the same height.

The drying stick has an upper end bent in a [symbol] shape. Preferably, the bent portion of the drying stick has a flat upper surface.

In the meantime, in another aspect of the present invention for achieving the object of the present invention, a drying rack in a dryer includes a seat having a plurality of pass through holes for pass through of drying air, a securing portion for supporting the seat spaced from a predetermined distance from an inside circumferential surface of the drying drum, and a drying stick at the seat for drying the drying object in a space spaced a distance from the seat.

The drying stick may be detachably mounted projected upward from the seat.

The drying rack may further include a branch stick at one side of the drying stick, the branch stick being branched in a direction different from the drying stick.

Preferably, both the drying stick and the branch stick have ends at the same height.

The drying rack may further includes a seating plate at the end of the drying stick for seating the drying object,

The drying stick has an upper end bent in a [symbol] shape, and, preferably, the bent portion of the drying stick has a flat upper surface.

### Advantageous Effects

By enabling to place the drying object, such as shoes, on a space spaced upward from a seat of the drying rack, the drying rack in a dryer of the present invention permits to increase a loading capacity of the drying rack, and to expose drying object to hot air uniformly, to improve drying efficiency.

### BRIEF DESCRIPTION OF THE DRAWINGS

The accompanying drawings, which are included to provide a further understanding of the invention, illustrate embodiments of the invention and together with the description serve to explain the principle of the invention. In the drawings;

FIG. 1 illustrates a perspective view of a related art drying rack;

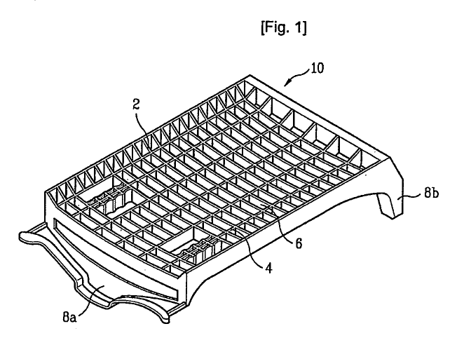

FIG. 2 illustrates a perspective view of a drying rack in accordance with a first preferred embodiment of the present invention; and

FIG. 3 illustrates a perspective view of a drying rack in accordance with a second preferred embodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

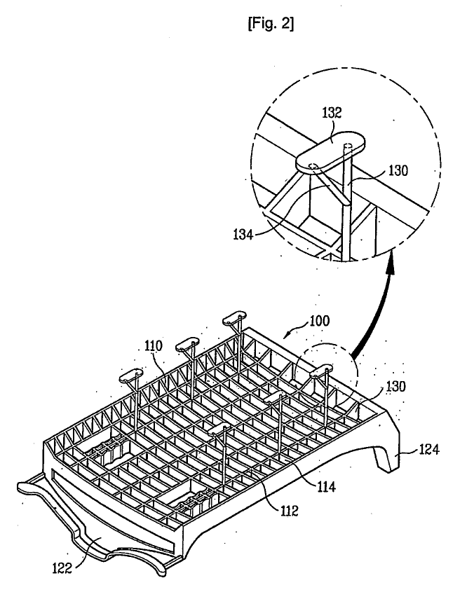

FIG. 2 illustrates a perspective view of a drying rack in accordance with a first preferred embodiment of the present invention, wherein the drying rack 100 includes drying sticks 130 for supporting drying objects over, and spaced from the rack the drying objects are to be placed thereon.

The rack includes a seat 110 for placing the drying objects thereon, and a securing portion 122, and 124 for supporting the seat 110 spaced from a predetermined distance from an inside circumferential surface of the drying drum (not shown).

Alike the related art, it is preferable that the securing portion 122, and 124 includes a front securing portion 122 at a front side of the seat 110, and a rear securing portion 124 at a rear side of the seat 110.

It is preferable that the securing portion 122, and 124 is mounted as the securing portion 122, and 124 is placed on an inside of the dryer, thereby being detachable from the dryer.

The seat 110 has a plurality of ribs 112 perpendicular to each other at regular intervals, to form pass through holes 114 between the ribs 112 for pass through of air.

The drying stick 130 supports the drying object spaced a predetermined distance from the seat 110 for drying the drying object spaced from the seat 110.

It is preferable that a plurality of the drying sticks 130 are detachably provided at regular intervals, each projected upward substantially vertically from the seat 110.

There may be a seating plate 132 with a predetermined width at an upper end of each of the drying sticks 130 for hanging or seating the drying object thereon.

There may be a branch stick 134 at one side of an upper portion of the drying stick 130 branched in a direction different from the drying stick 130.

Preferably, the branch stick 134 has one end fixedly secured to a side of the drying stick 130, and the other end connected to the seating plate 132 for supporting the seating plate 132.

It is preferable that a height of an upper end of the branch stick 134 is the same with an upper end of the drying stick 130.

It is preferable that the seating plate 132 connected between the upper end of the drying stick 130 and the upper end of the branch stick 134 is formed as one body with the drying stick 130 and the branch stick 134.

In the meantime, the branch stick 134 may be extended beyond the seating plate 132 without supporting the seating plate 132.

Moreover, the seating plate 132 may be formed only at the upper end of the drying stick 130, or only at the upper end of the branch stick 134, or both at the upper end of the drying stick 130, and at the upper end of the branch stick 134, separately.

The operation of the drying rack in a dryer of the present invention will be described.

The user mounts the drying rack 100 on an inside of a drying drum by using the front securing portion 122 and the rear securing portion 124, and places the drying object on the seat 110 of the drying rack 100, or on the seating plate 132 at the upper end of the drying stick 130 and the branch stick 134.

In this instance, when the drying object, such as a shoe, is placed on the seating plate 132, it is preferable that an entrance side of the shoe through which a foot enters is inserted in the seating plate 132, such that an underside surface of the shoe faces upward.

When a drying process is performed after placing the drying object oh the drying rack thus, the hot air is supplied, not only to the drying object on the seat 110, but also to the drying object, such as the shoe, on the drying stick 130, to dry the drying objects.

Moreover, since the drying objects on the drying stick 130 are not in direct contact with the ribs 112 of the seat 110, without being shaded by the ribs 112 from the hot air, drying by the hot air is made uniformly.

Moreover, as the drying stick 130 is detachable from the seat 110, if the drying stick 130 is not required, the drying stick 130 may be detached from the seat 110, to place the drying object on the seat.

Furthermore, if there are many drying objects, the drying objects may be placed both on the seat 110 of the drying rack 100, and the drying stick 130, for drying.

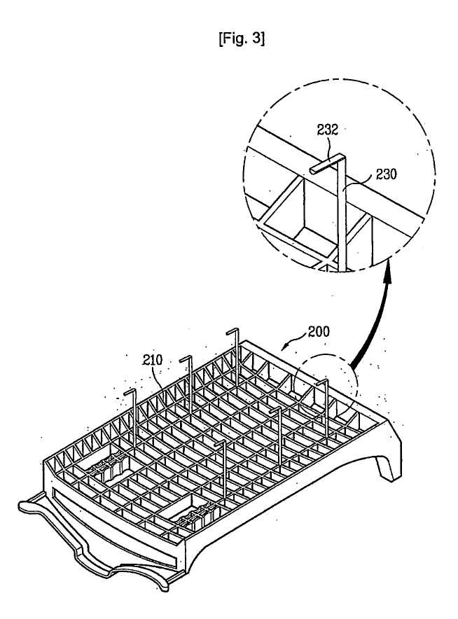

FIG. 3 illustrates a perspective view of a drying rack in accordance with a second preferred embodiment of the present invention.

Though the seating plate with a predetermined width is provided to the end of the drying stick in the first embodiment, in the second embodiment, the drying stick 230 upwardly detachable from the seat 210 may have an upper end 232 bent in a [symbol] shape.

It is preferable that the bent portion 232 of the drying stick has an upper flat surface, for easy placing of the drying object, such as a shoe.

Other portions of the second embodiment that are not described are the same with the first embodiment, of which detailed description will be omitted.

In the meantime, though the drying racks in above embodiments are described limited to a dryer, the drying rack is also applicable to a washing and drying machine having a drying function provided thereto.

### INDUSTRIAL APPLICABILITY

Since the drying object placed on the drying stick is not shaded by the ribs of the seat from the hot air, the drying rack in a dryer of the present invention can dry the drying object uniformly.

Since the drying stick is detachable, in a case the drying stick is not required, the drying stick may be detached, to place the drying object on the seat for drying the drying object.

Moreover, if there are many drying objects, the drying objects may be placed both on the seat of the drying rack and the drying stick, for drying the drying objects.

1. A drying rack in a dryer comprising:
a rack detachably mounted to an inside of a drying drum for placing a drying object thereon; and
at least one drying stick for supporting the drying object spaced a predetermined distance from the rack.

2. The drying rack as claimed in claim 1, wherein the rack includes;
a seat having a plurality of pass through holes for pass through of drying air; and
a securing portion for supporting the seat spaced from a predetermined distance from an inside circumferential surface of the drying drum.

3. The drying rack as claimed in claim 1, wherein the drying stick is detachable from the rack.

4. The drying rack as claimed in claim 1, wherein the drying stick is formed to be extended upward from the rack.

5. The drying rack as claimed in claim, further comprising a seating plate at an end of the drying stick for seating the drying object thereon.

6. The drying rack as claimed in claim 5, further comprising a branch stick having one end fixedly secured to a side of the drying stick, and the other end supporting the seating plate.

7. The drying rack as claimed in claim 6, wherein the branch stick is formed as one body with the drying stick.

8. The drying rack as claimed in claim 6, wherein the end of the drying stick and the end of the branch stick are at the same height.

9. The drying rack as claimed in claim 1, wherein the drying stick has an upper end bent in a “ [symbol] shape.

10. The drying rack as claimed in claim 9, wherein the bent portion of the drying stick has a flat upper surface.

11. A drying rack in a dryer comprising:
a seat having a plurality of pass through holes for pass through of drying air;
a securing portion for supporting the seat spaced from a predetermined distance from an inside circumferential surface of the drying drum; and
a drying stick at the seat for drying the drying object in a space spaced a distance from the seat.

12. The drying rack as claimed in claim 11, wherein the drying stick is detachably mounted projected upward from the seat.

13. The drying rack as claimed in claim 11, further comprising a branch stick at one side of the drying stick, the branch stick being branched in a direction different from the drying stick.

14. The drying rack as claimed in claim 13, wherein both the drying stick and the branch stick have ends at the same height.

15. The drying rack as claimed in claim 11, further comprising a seating plate at the end of the drying stick for seating the drying object.

16. The drying rack as claimed in claim 11, wherein the drying stick has an upper end bent in a [symbol] shape.

17. The drying rack as claimed in claim 16, wherein the bent portion of the drying stick has a flat upper surface.
